(19) United States
(12) Patent Application Publication
(10) Pub. No.: US 2013/0102753 A1
(43) Pub. Date: Apr. 25, 2013

(54) LOW RESIDUAL SOLVENT POLYAMIDEIMIDE POWDER FROM SUSPENSION POLYMERIZATION

(71) Applicant: FUJIFILM Hunt Chemicals, Inc., Allendale, NJ (US)

(72) Inventors: John Sidenstick, Newport, TN (US); Kathryn Mullins, Soddy Daisy, TN (US); Mace Phillips, Hixson, TN (US)

(73) Assignee: FUJIFILM Hunt Chemicals, Inc., Allendale, NJ (US)

(21) Appl. No.: 13/658,720

(22) Filed: Oct. 23, 2012

Related U.S. Application Data
(60) Provisional application No. 61/551,353, filed on Oct. 25, 2011.

(51) Int. Cl. C08G 73/14

(52) U.S. Cl. 528/48

(57) ABSTRACT

Disclosed is a method for generating a fine slurry of polyamideimide resin which can be conveniently isolated and dried. The product is completely free of dialkylamide solvents or other toxic substances.

### PRIORITY

The present patent application claims priority to and incorporates by reference the corresponding provisional patent application Ser. No. 61/551,353, titled, “Low Residual Solvent Polyamideimide Powder from Suspension Polymerization,” filed on Oct. 25, 2011.

### FIELD OF THE INVENTION

Embodiments of the present invention relate to the field of polyamideimide; more particularly, embodiments of the present invention relate to producing polyamideimide for polymerizations.

### BACKGROUND OF THE INVENTION

Polyamideimide (PAI) polymers are used for many high performance coating applications due to their excellent temperature resistance and high strength. The primary route to synthesizing polyamideimide polymers in a form that is convenient for the manufacture of coatings is reacting diisocyanate, often 4,4′-methylene diphenyldiisocyanate (MDI) with trimellitic anhydride (TMA). In this process, PAI polymers are typically synthesized in polar aprotic solvents such as dimethylformamide, dimethylacetamide, N-methylpyrrolidone (NMP), and N-ethylpyrrolidone. See, for example, U.S. Pat. Nos. 2,421,021; 3,260,691; 3,471,444; 3,518,230; 3,817,926; and 3,847,878. The typical polymer solids level achieved in this synthetic route is 35-45% which may be diluted further with diluents depending on the end-use coating application.

On a practical level, the manufacture of polyamideimde resins has been limited more specifically to the use of high boiling dialkylamides as the polar aprotic solvent in which the reaction temperature can be elevated to as high as 150° C. and the product polyamideimide is soluble. Although useful for synthesizing PAI, these solvents known in the art are also recognized for having environmental and toxicity concerns.

High boiling dialkyamide solvents in particular have environmental concerns and are therefore regulated as volatile organic compounds (VOCs), considered to be hazardous air pollutants (HAPs), and are restricted in their usage. Thus it is an advantage to produce polyamideimide polymers using a synthetic method with minimal environmental impact. In an effort to achieve this, alternative solvents and processes are necessary.

In addition, a process that is shorter in reaction time and that requires less energy also has environmental, as well as economic, advantages.

A further environmental improvement is to produce the PAI resin in a compact form for handling and transportation with minimal residual solvent. To achieve this, a solid, slurry, or semi-solid form of the PAI resin is preferred.

Therefore, a process that achieves all of these targets is desired.

Suspension polymerizations have been described for manufacturing slurries of resins by radical polymerizations and the use of catalysts, for example U.S. Pat. No. 4,543,401. Many important polymers are made commercially via suspension polymerization. These include poly(vinyl chloride) (PVC), poly(methyl methacrylate), expandable polystyrene, and styrene-acrylonitrile copolymers.

### SUMMARY OF THE INVENTION

Disclosed is a method for generating a fine slurry of polyamideimide resin which can be conveniently isolated and dried. The product is completely free of dialkylamide solvents or other toxic substances.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a chemical process.

FIG. 2 illustrates a graph of Isocyanate vs. the square root of the time.

### DETAILED DESCRIPTION OF THE PRESENT INVENTION

To achieve these environmental improvements and other advantages, it has now been unexpectedly found that the synthesis of PAI can be accomplished by suspension polymerization under the appropriate conditions and the selective use of environmentally safer and lower toxicity solvents. In one embodiment of the process described herein, an ionic step-wise polymerization is provided to generate a polyamideimide resin suitable for coatings applications under certain synthesis conditions used to optimize formation of the slurry or solid resin through the selection, testing, and use of low toxicity, low boiling solvents. Examples of these solvents are acetone, ethyl acetate, propylene carbonate, and dimethyl carbonate. The synthesis process for producing PAI includes the reaction of 4,4′-methylenediphenyldiisocyanate (MDI) with trimellitic anhydride (TMA).

Use of the ionic suspension polymerization method has the further advantage, over the prior art of dispersion polymerization, to achieve low particle size of the synthesized PAI resin. While prior art dispersion polymerization requires high sheer mixing by the nature of ionic suspension polymerization, in the embodiments of the invention, only low sheer mixing is needed to produce a low particle size, generally in the range of 200 micron or less.

In one embodiment of the inventive synthetic process, it has been found that the initially-formed intermediate monomer is soluble in the inventive solvents and in which the PAI resin is essentially insoluble in the solvents, allowing the direct formation of a slurry of the polymer under elevated pressure. This can be done with or without an added catalyst. In addition, the synthesis process can be done with or without an added co-solvent. In one embodiment, if a co-solvent is used, a maximum of 20% of the total solvent content is the co-solvent.

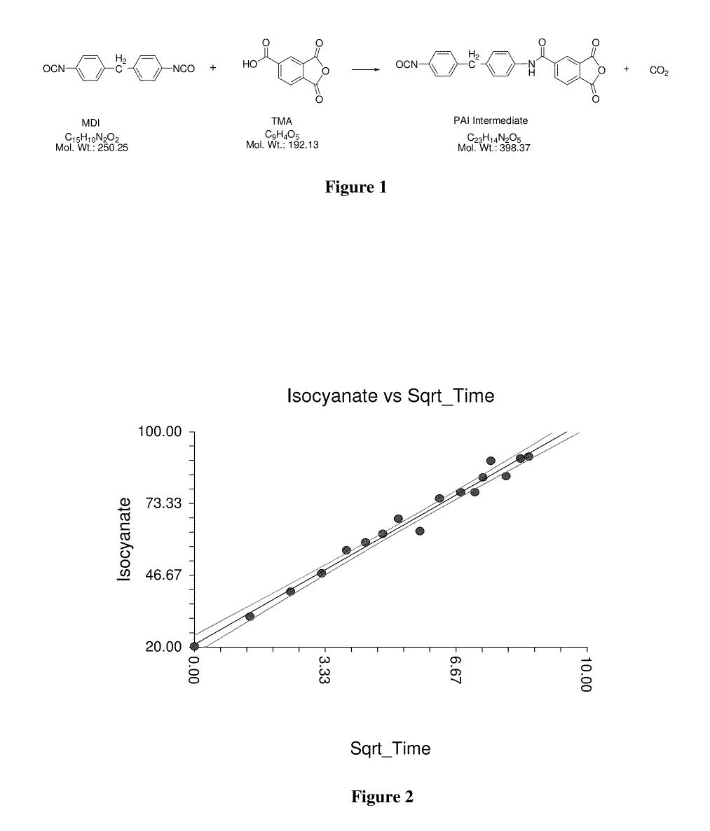

In one embodiment, acetone is used as the low-boiling, zero VOC solvent for the reaction, and water (500-2500 ppm), TMA, or its hydrolysis product effectively catalyzes the condensation. The use of such solvents as acetone produces a rapid reaction to form the intermediate monomer at less than the boiling point of acetone (56° C.) and is essentially complete in <3 hours at reflux. Although TMA dissolves slowly, it reacts readily when dissolved. Upon complete dissolution, a clear to slightly hazy solution exists. Analysis by FTIR shows no O—H remaining, which contributes to haziness or incomplete dissolution in the solvent, indicating that formation of the intermediate is complete. The process can be described in FIG. 1. The progress of PAI polymer resin formation can be monitored by FTIR percent transmittance (% T ) due to absorbance of the isocyanate at a wavelength equal to 2271 cm⁻¹. Although further condensation will progress at 56° C. (95% T, 120 hours), running under a back pressure of 37 psig at 90° C. allows more rapid conversion (95% T, 30 hours).

The reaction shows the characteristic kinetics of a step-wise polymerization, where conversion is proportional to square root of time at a given temperature and back pressure. This is shown in FIG. 2.

Since log molecular weight is proportional to % T, molecular weight can be substantially controlled and allows generation of any desired molecular weight, typically 8,000-12,000 for a dissolvable PAI polymer resin suitable for end use coatings applications such as cookware and can coatings.

Once desired conversion is reached, residual isocyanate is blocked by the addition of dimethylethanolamine or other suitable blocking agent such as primary and secondary amines, tertiary amino alcohols, or other agents which will eliminate during the curing process.

Further, upon completion of the conversion, there is no need for re-purification of the synthesized PAI resin which is produced in slurry, solid, or semi-solid form with a particle size of less than or equal to 200 microns.

Additionally, the PAI resin is readily dissolvable and can be diluted further with either water or solvent diluents, depending on the end-use coating application, to produce either solvent or aqueous coating systems.

The advantages of embodiments of the inventive process of ionic suspension polymerization with the described conditions and composition are that the process and synthesized PAI resin has the following characteristics when compared to the dispersion process of the prior art.
1. A compact, high-solids content PAI of equal to or greater than 90% is produced by the ionic suspension polymerization process described herein.
2. A low boiling solvent with low or zero VOC is used in the ionic suspension polymerization synthesis described herein.
3. A low residual solvent PAI is obtained which is free of VOCs, HAPs, and alkylamides in the final resin with the use of the ionic suspension polymerization process described herein.
4. The ionic suspension polymerization process described herein allows a shorter process time to produce the PAI resin.
5. The ionic suspension polymerization process described herein can control the molecular weight which is achieved.
6. A low sheer process is used to achieve the desired particle size.
7. Reduced particle size of equal to or less than 200 μm is attained and where minimal agglomeration or gel formation occurs.
8. PAI resin slurry is amenable to spray drying.
9. The ionic suspension polymerization process described herein allows the modification of end groups for the formation of the PAI resin.
10. The ionic suspension polymerization process described herein is used which does not require the addition of additives or dispersants to achieve the above features.

The advantages of embodiments of the inventive process can be demonstrated in the following examples.

### EXAMPLES

### Example 1

562.41 grams (g) MDI and 428.8 g TMA are charged to a 5 L round bottomed flask. 627.17 g o-xylene and 314.77 g acetone are charged. Reaction is heated to 80° C. over 4 hours, evolving 1 equivalent of CO2. Reaction is then heated to 90-95° C. and maintained at reflux. As the reaction mass thickens, acetone is added and reflux temperature drops. Reaction was judged complete at 80% T (20 hours). 11.6 g water is added and reaction held until isocyanate absorbance disappeared. The product slurry, ˜23% solids, was filtered and dried yielding 804.2 g with a 90% yield (95.44% solids) using an Ohaus Moisture Balance at 200° C.

### Example 2

555.62 g MDI, 428.96 g TMA, 506.8 g o-xylene and 225.93 g acetone were heated to 76° C. over 4 hours; material completely dissolved at ˜2 hours (t=0). Acetone was added as the reaction mass thickened. A Tₘₐₓ=82° C. was recorded and a temperature of 65-69° C. was maintained for most of the reaction. Conversion was continued until % T=82% (27 hours). 28.51 g methanol was added and reaction held until isocyanate was gone. Material was filtered and dried to give 494.4 g, 62.9% yield.

### Example 3

53.03 g MDI, 41.15 g TMA and 219.0 g acetone were charged to a round bottomed flask equipped with magnetic stifling. Heating is begun as materials are being charged and it is noted that the CO2 off gas is quite vigorous when it was charged (at ˜35° C.). All TMA was dissolved and a clear light yellow solution was obtained at 55° C. in 25 min. Precipitate was observed at ˜1 hr and FTIR showed >60% T at 1.5 hours. The reactor was still open to atmosphere with vigorous acetone reflux. The vent was closed and the reactor heated to 80° C. with frequent venting. After 3.5 hours at 80° C. with occasional venting the % T=87.5% and venting was discontinued except for sampling. Desired conversion (>95% T) was reached in 24 hours. 2.9 g DMEA was charged to eliminate isocyanate/cap end groups. The resultant slurry was spray dried at room temperature and then dried in a convection oven at 110° C. for 2 hours, yielding 70.49 g of 92.77% solids (200° C.) powder, providing an 87% yield.

### Example 4

41.15 g trimellitic anhydride and 53.03 g methylene diphenyl isocyanate are charged to 219 g acetone. The reaction is heated slowly to reflux with off-gassing of CO2. After the loss of 1 eq. of CO2 (9.3 g, FTIR % T at 2271 cm⁻¹>60% after 1.5 h), the temperature was increased to 80° C. and vent was closed. Reaction was maintained at 80° C. with periodic venting until % T at 2271cm⁻¹>95%, 10 h). Once conversion reached desired level, 2.9 g dimethylethanolamine was added and reaction held until % T at 2271 cm⁻¹ reached baseline. The resulting slurry was spray dried to yield 70.5 g of powder, 92.8% solids.

### Example 5

In a 600 mL Parr reactor, 145.8 g acetone, 38.5 g methylene diphenyl diisocyanate, and 29.84 g trimellitic anhydride, were charged and the system was then hermetically sealed and agitated. The system was held at 35° C. for a period of 30 minutes and, with an exotherm of 21° C., the system showed the first sign of pressure at an internal temperature of 54° C., 8 psi. The internal temperature of the reactor was then increased to 90° C. in 5° C. increments, over the course of 3.5 hours. During this period, the pressure showed a steady increase as the internal temperature did, going from 10 psi at 55° C. to 36 psi at 90° C. The internal temperature of the reactor was then brought to 105° C. and held for 6 hours. During this time, the pressure of the reactor showed a steady climb until, at 56 psi and 6 hours into the reaction, the pressure was vented down to 40 psi for safe measure. After this off-gas, over the next 5 hours the system again reached up to a pressure of 68 psi before the reactor was cooled and vented to atmospheric conditions. A total reaction time of 11 hours resulted in 78.3% conversion of isocyanate by FTIR. The products obtained were very dark and agglomerated, suggesting that the pressure, temperature, or both were too high for the desired PAI characteristics to be attained.

Table 1 below shows the data attained from the experiment Example 5.

TABLE 1
Example 5

| | | Actual | Pressure | | | |
|---|---|---|---|---|---|---|
| Time | Set T | T | (P) | Off-gased P | Σ(off-gased P) | Σ(P) |
| (Hrs) | (° C.) | (° C.) | (PSI) | (PSI) | (PSI) | (PSI) |
| 0:00 | 35 | 21 | 0 | 0 | 0 | 0 |
| 0:31 | 35 | 54 | 8 | 0 | 0 | 8 |
| 0:44 | 55 | 57 | 9 | 0 | 0 | 9 |
| 1:00 | 55 | 55 | 10 | 0 | 0 | 10 |
| 2:29 | 55 | 55 | 12 | 0 | 0 | 12 |
| 2:35 | 60 | 64 | 16 | 0 | 0 | 16 |
| 3:07 | 65 | 66 | 18 | 0 | 0 | 18 |
| 3:14 | 70 | 72 | 20 | 0 | 0 | 20 |
| 3:23 | 75 | 77 | 24 | 0 | 0 | 24 |
| 3:32 | 80 | 82 | 28 | 0 | 0 | 28 |
| 3:37 | 85 | 85 | 31 | 0 | 0 | 31 |
| 4:06 | 90 | 90 | 36 | 0 | 0 | 36 |
| 4:12 | 95 | 95 | 40 | 0 | 0 | 40 |
| 4:17 | 100 | 100 | 44 | 0 | 0 | 44 |
| 4:26 | 105 | 107 | 52 | 0 | 0 | 52 |
| 4:38 | 105 | 104 | 52 | 0 | 0 | 52 |
| 5:34 | 105 | 105 | 55 | 0 | 0 | 55 |
| 5:56 | 105 | 104 | 56 | 0 | 0 | 56 |
| 5:58 | 105 | 102 | 40 | 16 | 16 | 56 |
| 5:59 | 105 | 103 | 42 | 0 | 16 | 58 |
| 10:38 | 105 | 105 | 44 | 0 | 16 | 60 |

### Example 6

In a 600 mL Parr reactor, the following reagents were charged: 145.2 g acetone, 38.7 g methylene diphenyl diisocyanate, and 29.8 g trimellitic anhydride. The system was then hermetically sealed before adding in heat and agitation. The system was held at 65° C. for a period of 18 hours, but besides the initial exotherm, seen in Table 2, no sign of pressure was observed. A sample was taken and FTIR showed 36.15% conversion of the isocyanate. The internal temperature of the reactor was then increased to 80° C. and held for 23 hours. 9 hours into the 23 hour hold, a sample was taken and the conversion of isocyanates had increased to 59.8%. The system stayed below a pressure of 20 psi throughout the 48 hr reaction. The final analysis showed 84.2% conversion of isocyanates. To hydrolyze the isocyanate to completion, 13.04 g deionized water was added to the slurry which was heated to 70° C. for a period of 7 hours, after which the conversion had gone to 90.8% hydrolyzed The resulting powder showed little residual solvent; with a % solids of 90.16%, but when re-dissolved in NMP for characterization, the viscosity went from an initial 1424 cps→EEEE on the DVIII @23° C.

Table 2 below shows the data attained from the experiment Example 6.

TABLE 2
Example 6

| | | | | Pressure | Off- | Σ(off- | |
|---|---|---|---|---|---|---|---|
| Time | Time | Set T | Actual T | (P) | gassed P | gassed P) | Σ(P) |
| (Hrs) | (Hrs) | (° C.) | (° C.) | (PSI) | (PSI) | (PSI) | (PSI) |
| 14:50 | 0:00 | 55.00 | 81.00 | 10.00 | 0.00 | 0.00 | 10.00 |
| 14:56 | 0:06 | 55.00 | 76.00 | 8.00 | 0.00 | 0.00 | 8.00 |
| 15:17 | 0:27 | 55.00 | 69.00 | 0.00 | 0.00 | 0.00 | 0.00 |
| 15:35 | 0:45 | 65.00 | 65.00 | 0.00 | 0.00 | 0.00 | 0.00 |
| 17:00 | 2:10 | 65.00 | 65.00 | 0.00 | 0.00 | 0.00 | 0.00 |
| 19:00 | 4:10 | 65.00 | 65.00 | 0.00 | 0.00 | 0.00 | 0.00 |
| 21:00 | 6:10 | 65.00 | 65.00 | 0.00 | 0.00 | 0.00 | 0.00 |
| 23:00 | 8:10 | 65.00 | 65.00 | 0.00 | 0.00 | 0.00 | 0.00 |
| 1:00 | 10:10 | 65.00 | 65.00 | 0.00 | 0.00 | 0.00 | 0.00 |
| 3:00 | 12:10 | 65.00 | 65.00 | 0.00 | 0.00 | 0.00 | 0.00 |
| 5:00 | 14:10 | 65.00 | 65.00 | 0.00 | 0.00 | 0.00 | 0.00 |
| 7:00 | 16:10 | 65.00 | 65.00 | 0.00 | 0.00 | 0.00 | 0.00 |
| 9:23 | 18:33 | 65.00 | 65.00 | 0.00 | 0.00 | 0.00 | 0.00 |
| 9:50 | 19:10 | 75.00 | 30.00 | 0.00 | 0.00 | 0.00 | 0.00 |
| 10:00 | 19:36 | 75.00 | 78.00 | 10.00 | 0.00 | 0.00 | 10.00 |
| 10:26 | 19:44 | 80.00 | 74.00 | 7.00 | 0.00 | 0.00 | 7.00 |
| 10:34 | 19:46 | 80.00 | 74.00 | 7.00 | 0.00 | 0.00 | 7.00 |
| 10:36 | 19:51 | 80.00 | 85.00 | 15.50 | 0.00 | 0.00 | 15.50 |
| 10:41 | 19:54 | 80.00 | 88.00 | 17.50 | 0.00 | 0.00 | 17.50 |
| 10:44 | 20:01 | 80.00 | 86.00 | 16.00 | 0.00 | 0.00 | 16.00 |
| 10:51 | 20:04 | 80.00 | 84.00 | 14.00 | 0.00 | 0.00 | 14.00 |
| 10:54 | 20:36 | 80.00 | 79.00 | 11.00 | 0.00 | 0.00 | 11.00 |
| 11:26 | 20:50 | 80.00 | 80.00 | 11.00 | 0.00 | 0.00 | 11.00 |
| 11:40 | 22:21 | 80.00 | 80.00 | 12.00 | 0.00 | 0.00 | 12.00 |
| 13:11 | 23:47 | 80.00 | 80.00 | 14.00 | 0.00 | 0.00 | 14.00 |
| 14:37 | 1:41 | 80.00 | 80.00 | 17.50 | 0.00 | 0.00 | 17.50 |
| 16:31 | 1:55 | 80.00 | 80.00 | 17.00 | 0.00 | 0.00 | 17.00 |
| 16:45 | 2:03 | 80.00 | 77.00 | 10.00 | 10.00 | 10.00 | 20.00 |

Particle size analyses of resulting PAI resin samples from Examples 1 through 6 show a mean particle size diameter of from about 4 micron to about 60 micron. In addition, the 90^{th} percentile mean particle size diameter (d90 value) is about 150 micron or less and only a minor portion of particles having a maximum particle size of 200 micron.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A process for producing polyamideimide comprising:
using an aprotic solvent which is a low boiling compound;
using suspension polymerization;
using high pressure processing; and
using high temperature processing to produce a polyamideimide resin in the form of a slurry, solid or semi-solid.

2. The process of claim 1 where content of the low boiling solvent is used in the process at from about 80 to about 100% of the total solvent content.

3. The process of claim 1 where the produced polyamideimide resin contains less than about 10% residual low boiling solvent by suspension polymerization.

4. The process of claim 1 where the low boiling solvent is acetone, ethyl acetate, dimethyl carbonate, or propylene carbonate.

5. The process of claim 1 where the solvent is acetone.

6. The process of claim 1 where the suspension polymerization process is an ionic suspension polymerization.

7. The process of claim 1 where the reaction temperature is from about 56° C. to about 140° C.

8. The process of claim 1 where the pressure is from about 0 to about 120 psig.

9. The process of claim 1 where the produced polyamide has a particle size of less than or equal to about 200 microns.

10. The process of claim 1 where the produced polyamide has a particle size of less than or equal to about 150 microns.

11. A process of claim 1 where the resultant slurry is spray dried.

12. The polyamideimide product of the process of claims 1-11.
